(19) United States
(12) Patent Application Publication
(10) Pub. No.: US 2014/0201347 A1
(43) Pub. Date: Jul. 17, 2014

(54) System And Method For Implementing A Command Center In An Electronic Network

(71) Applicants: Tom Lam, San Diego, CA (US); Robert Cowie, Escondido, CA (US); Tam Dao, San Marcos, CA (US); Don Nguyen, Temecula, CA (US)

(72) Inventors: Tom Lam, San Diego, CA (US); Robert Cowie, Escondido, CA (US); Tam Dao, San Marcos, CA (US); Don Nguyen, Temecula, CA (US)

(21) Appl. No.: 13/742,687

(22) Filed: Jan. 16, 2013

(51) Int. Cl. H04L 12/24

(52) U.S. Cl. CPC H04L 41/00
USPC 709/223

(57) ABSTRACT

A method for managing an electronic network includes a main device that utilizes a command center for performing device management procedures on behalf of auxiliary devices in the electronic network. The auxiliary devices each include a command module that bi-directionally communicates with the command center to receive device control information during the device management procedures.

### BACKGROUND SECTION

1. Field of the Invention

This invention relates generally to techniques for managing electronic devices, and relates more particularly to a system and method for implementing a command center in an electronic network.

2. Description of the Background Art

Implementing effective methods for managing electronic devices is a significant consideration for designers and manufacturers of contemporary electronic systems. However, effectively managing electronic devices may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced functions may provide additional benefits to a system user, but may also place increased demands on the control and management of various system components. For example, an enhanced electronic network device that effectively supports video information may benefit from an effective implementation because of the large amount and complexity of the digital data involved.

Due to growing demands on system resources and substantially increasing data magnitudes, it is apparent that developing new techniques for managing electronic devices is a matter of concern for related electronic technologies. Therefore, for all the foregoing reasons, developing effective techniques for providing management services remains a significant consideration for designers, manufacturers, and users of contemporary electronic devices.

### SUMMARY

In accordance with the present invention, a system and method for utilizing a command center to perform device management procedures in an electronic network are disclosed. In one embodiment, the command center may be implemented as part of a central main device in the electronic network. In addition, the electronic network may include any number of auxiliary devices.

In accordance with the present invention, the command center may be utilized to efficiently control, manage, and coordinate various types of operations and tasks for the auxiliary devices. This centralized functionality of the command center provides an improved method for performing various device management tasks without requiring a system user to inefficiently move to individual auxiliary devices to repetitiously perform similar tasks. Instead, all tasks may be centrally controlled from the command center on the main device.

In one embodiment of the present invention, an appropriate entity such as a system administrator may designate which auxiliary devices are authorized to participate in device management procedures controlled by the command center. The command center then monitors the electronic network to determine whether any tasks have been triggered or requested. In various embodiments, a task may be triggered in response to corresponding trigger events that occur in the electronic network. For example, one or more auxiliary devices may communicate with command center to provide notifications about specific trigger events. Alternately, the command center may affirmatively detect the trigger events in any effective manner.

If the command center determines that a task has been triggered, then the command center identifies the specific task that has been triggered in any suitable manner. For example, the command center may reference a local or remote task database. The command center may then generate corresponding task instructions by utilizing any appropriate techniques. For example, task instructions may be associated with respective supported tasks in the task database.

The command center may encode or encrypt the task instructions utilizing any type of encryption technique. The command center next transmits the task instructions to at least one target auxiliary device. A command module of the auxiliary device may then decode or decrypt the received task instructions. The command module of the auxiliary device may perform an analysis procedure on the task instructions to prepare for correctly executing the task instructions. The command module of the auxiliary device then causes the auxiliary device to perform the specified task according to the received task instructions.

Finally, the command module acknowledges to the command center on the main device that the task instructions have been executed and the task has been successfully completed. The device management procedure may then terminate. For at least the foregoing reasons, the present invention therefore provides an improved system and method for utilizing a command center to perform a device management procedure in an electronic network.

### BRIEF DESCRIPTION OF THE DRAWINGS

FIG. 1 is a block diagram of an electronic network, in accordance with one embodiment of the present invention;

FIG. 2 is a block diagram for one embodiment of the main device of FIG. 1, in accordance with the present invention;

FIG. 3 is a block diagram for one embodiment of the memory of FIG. 2, in accordance with the present invention;

FIG. 4A is a block diagram of the command center from FIG. 3, in accordance with one embodiment of the present invention;

FIG. 4B is a block diagram of the task database from FIG. 3 in accordance with one embodiment of the present invention;

FIG. 5 is a block diagram for one embodiment of an auxiliary device from FIG. 1, in accordance with the present invention;

FIG. 6 is a block diagram for one embodiment of the memory of FIG. 5, in accordance with the present invention; and

FIG. 7 is a block diagram for one embodiment of the command module from FIG. 6, in accordance with the present invention; and

FIGS. 8A-8C are a flowchart of method steps for utilizing a command center to perform a device management procedure in an electronic network, in accordance with one embodiment of the present invention.

### DETAILED DESCRIPTION

The present invention relates to an improvement in device management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for managing devices in an electronic network, and includes a central main device that utilizes an intelligent command center for performing device management procedures on behalf of various auxiliary devices in the electronic network. The auxiliary devices each include a command module that bi-directionally communicates with the command center to receive various types of device control information during the device management procedures.

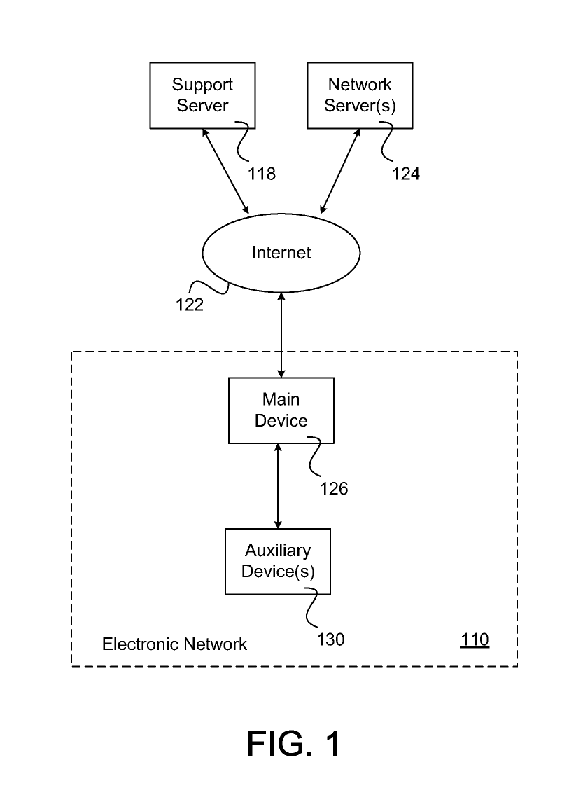

Referring now to FIG. 1, a block diagram of an electronic network 110 is shown, in accordance with one embodiment of the present invention. In the FIG. 1 embodiment, electronic network 110 may include, but is not limited to, a main device 126 and one or more auxiliary devices (aux devices) 130. The FIG. 1 embodiment also includes a support server 118 and one or more network servers 124. In alternate embodiments, electronic network 110 may be implemented by utilizing components and configurations in addition to, or instead of, certain of those components and configurations discussed in conjunction with the FIG. 1 embodiment.

In the FIG. 1 embodiment, electronic network 110 may be implemented as any type of electronic network. For example, main device 126 and aux devices 130 may include, but are not limited to, smart, network-enabled devices that are connected in a local-area network, a wide-area network, a peer-to-peer network, or any other remote or local network configuration. In addition, electronic network 110 may be implemented in any desired type of environment including, but not limited to, a home environment, a school environment, and a business environment.

In accordance with the present invention, main device 126 may include a command center (not shown) that may be utilized to efficiently control, manage, and coordinate various types of operations and tasks for the aux devices 130 in electronic network 110 from a single central main device 126. This centralized functionality of the command center on main device 126 provides an improved method for performing various device management tasks without requiring a system user to inefficiently move to individual aux devices 130 throughout electronic network 110 to repetitiously perform similar tasks. Instead, all tasks may be centrally controlled from the command center on main device 126.

In certain embodiments, main device 126 may communicate with one or more network servers 124 through the Internet 122 or other appropriate means to obtain relevant information for managing electronic network 110. For example, main device 126 may access network servers 124 from various software and hardware manufacturers to obtain software updates, troubleshooting information, product specifications, and any other types of information for managing electronic network 110.

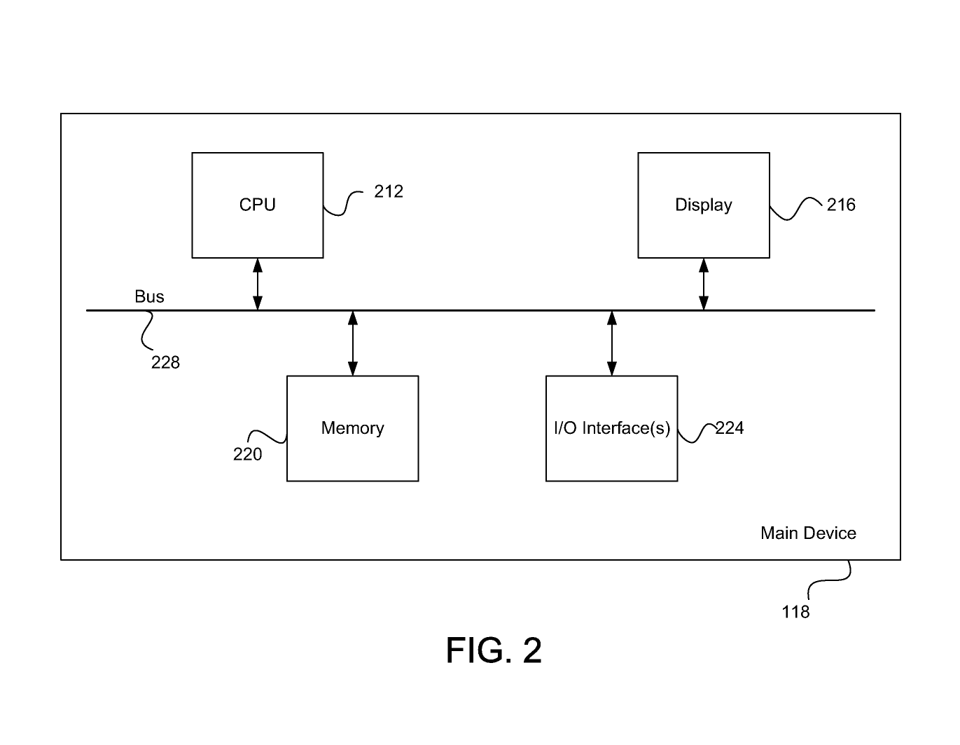

In certain embodiments, main device 126 may also communicate with a support server 118 through the Internet 122 or other appropriate means to obtain technical support for aux devices 130 or main device 126 in electronic network 110. For example, one or more aux devices 130 may provide a problem notification to main device 126 regarding a technical problem in electronic network 110. Main device 126 may then transmit a service request to support server 118 regarding the technical problem. In response, a technical support person may utilize support server 118 to communicate with main device 126 and/or one or more aux devices 130 to diagnose and provide a suitable solution to the technical problem. Additional details regarding the implementation and utilization of electronic network 110 are further discussed below in conjunction with FIGS. 2-8

Referring now to FIG. 2, a block diagram for one embodiment of the FIG. 1 main device 126 is shown, in accordance with the present invention. In the FIG. 2 embodiment, main device 126 includes, but is not limited to, a central processing unit (server CPU) 212, a display 216, a memory 220, and one or more input/output interface(s) (server I/O interface(s)) 224. The foregoing components of main device 126 may be coupled to, and communicate through, a bus 228. In alternate embodiments, main device 126 may alternately be implemented using components and configurations in addition to, or instead of, certain of those components and configurations discussed in conjunction with the FIG. 2 embodiment.

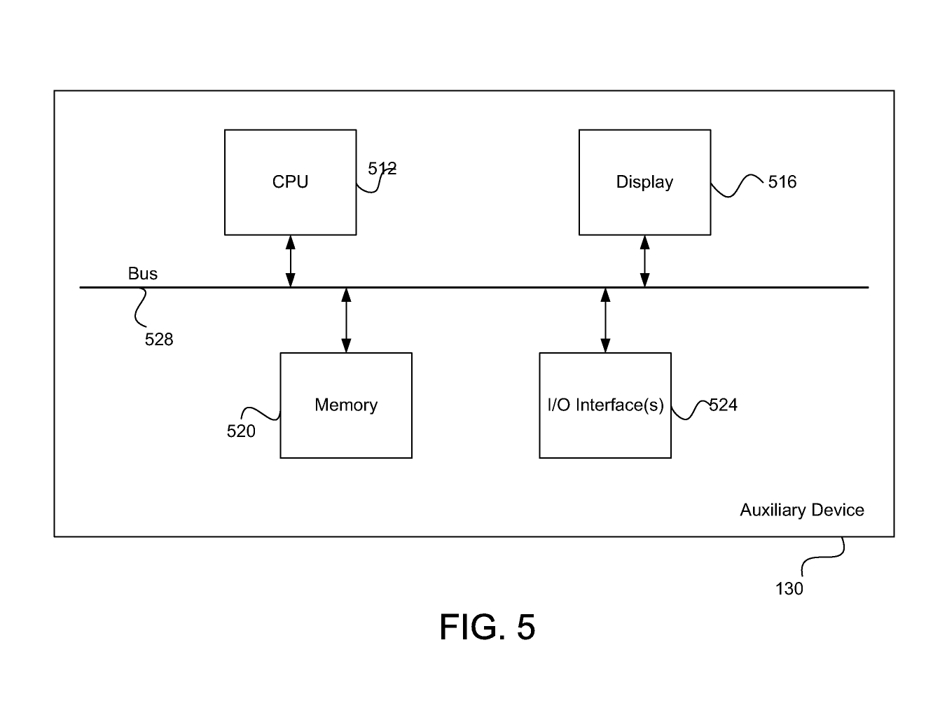

Furthermore, in the FIG. 5 embodiment, main device 126 may be implemented as any type of appropriate entity. For example, in certain embodiments, main device 126 may be implemented as any type of stationary or portable electronic device, such as a personal computer, a network-enabled smart television, a consumer-electronics device, a cellular telephone, a set-top box, an audio-visual entertainment device, or a personal digital assistant (PDA).

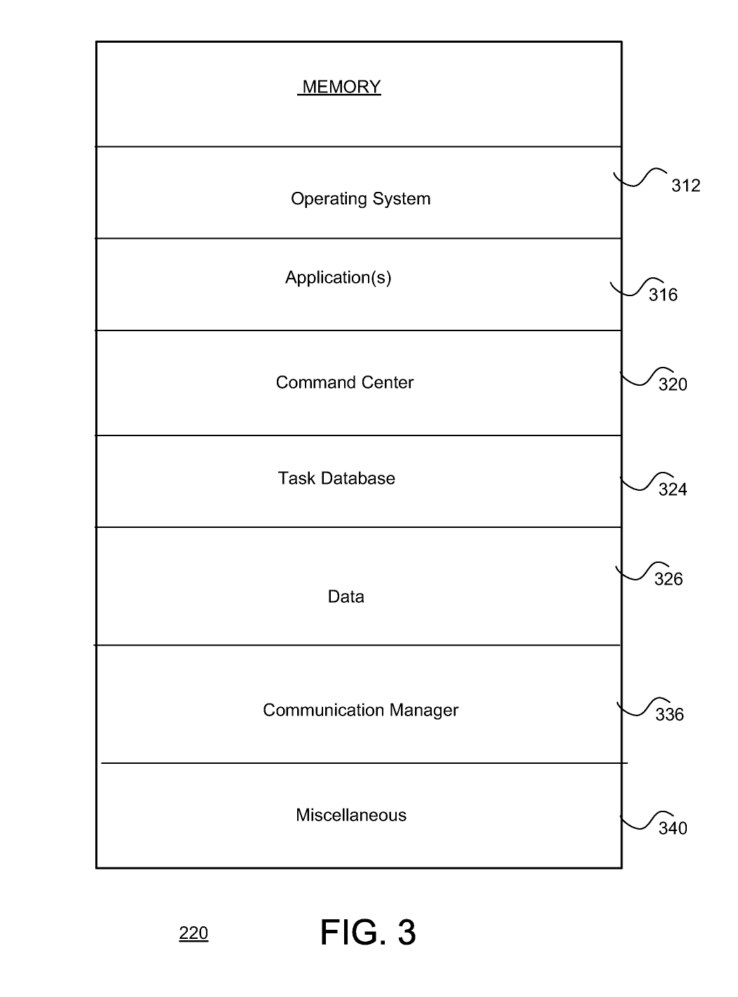

In the FIG. 2 embodiment, CPU 212 may be implemented to include any appropriate and compatible microprocessor device that executes software instructions to thereby control and manage the operation of main device 126. The FIG. 2 server 216 may include any effective type of display technology including a cathode-ray-tube monitor or a liquid-crystal display device with an appropriate screen for displaying various information to a device user. In the FIG. 2 embodiment, memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of memory 220 are further discussed below in conjunction with FIG. 3.

In the FIG. 2 embodiment, I/O interface(s) 224 may include one or more input and/or output interfaces to receive and/or transmit any required types of information by main device 126. I/O interface(s) 224 may include one or more means for allowing a device user to communicate with main device 126. The implementation and utilization of main device 126 is further discussed below in conjunction with FIGS. 3-8.

Referring now to FIG. 3, a block diagram for one embodiment of the FIG. 2 memory 220 is shown, in accordance with the present invention. In the FIG. 3 embodiment, memory 220 may include, but is not limited to, an operating system 312, one or more applications 316, a command center 320, a task database 324, data 326, a communication manager 336, and miscellaneous information 340. In alternate embodiments, memory 220 may include various other components and functionalities in addition to, or instead of, certain those components and functionalities discussed in conjunction with the FIG. 3 embodiment.

In the FIG. 3 embodiment, operating system 312 may perform various low-level functions for main device 126. In the FIG. 3 embodiment, applications 316 may include program instructions that are preferably executed by CPU 212 (FIG. 2) to perform various functions and operations for main device 126. The particular nature and functionality of applications 312 typically vary depending upon factors such as the specific type and particular functionality of the corresponding main device 126.

In the FIG. 3 embodiment, command center 320 may include any effective means for managing device management procedures for aux devices 130 in electronic network 110 (FIG. 1). In the FIG. 3 embodiment, task database 324 may include specific tasks and corresponding task instructions that are supported by command center 320. Data 326 may include any type of information for utilization by main device 126. In the FIG. 3 embodiment, communication manager 336 may perform appropriate communication functions with aux devices 130, network servers 124, and solution server 118 (FIG. 1) to transfer any appropriate type of information. Miscellaneous information 340 may include any additional information for utilization by main device 126.

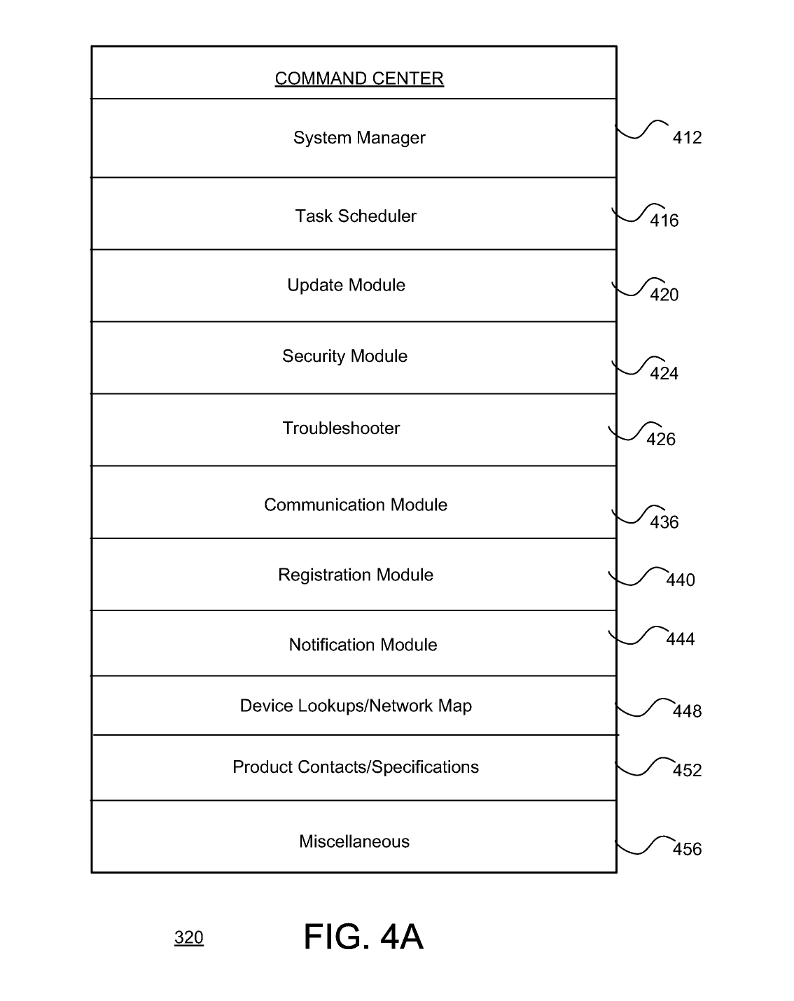

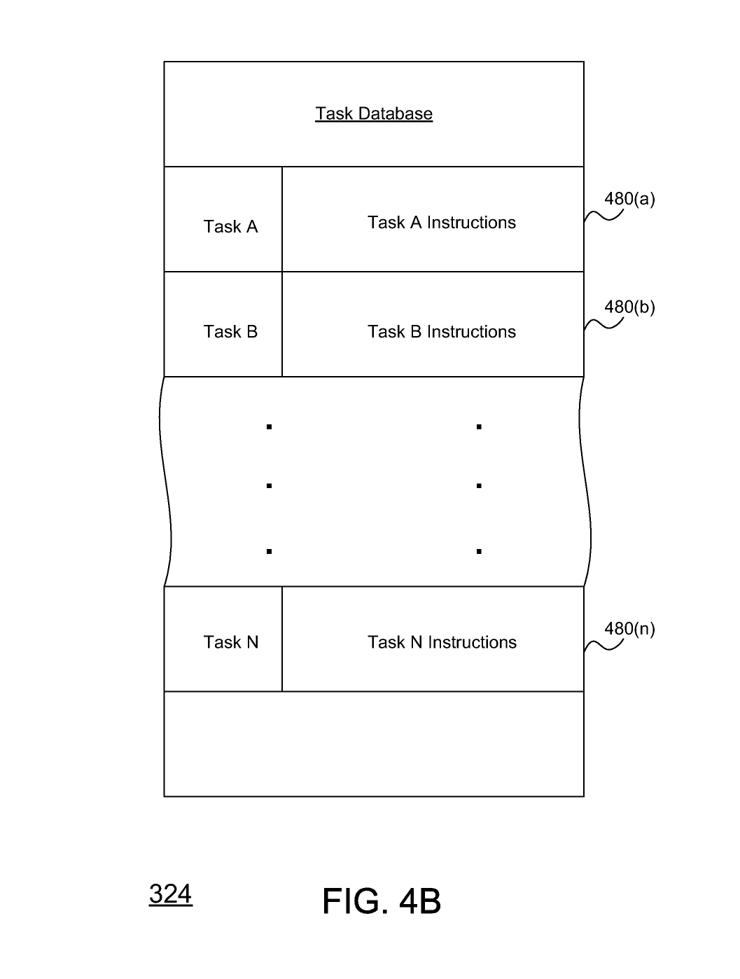

In the FIG. 3 embodiment, the present invention is disclosed and discussed as being implemented primarily as software. However, in alternate embodiments, some or all of the functions of the present invention may be performed by appropriate electronic hardware circuits that are configured for performing various functions that are equivalent to those functions of the software modules discussed herein. Additional details regarding the operation and implementation of command center 320 are further discussed below in conjunction with FIGS. 4 through 8.

Referring now to FIG. 4A, a diagram for one embodiment of the FIG. 3 command center 320 is shown, in accordance with the present invention. The FIG. 4A embodiment is presented for purposes of illustration, and in alternate embodiments, command center 320 may include components and information in addition to, or instead of, certain of those components and information discussed in conjunction with the FIG. 4A embodiment. For example, command center 320 may be readily updateable in the future, either by a new release of the software or by downloading new/updated modules from the support server.

In the FIG. 4A embodiment, system manager 412 functions to provide overall control, management, and coordination of the various functionalities of command center 320. In the FIG. 4A embodiment, system manager 412 may utilize task scheduler 416 to schedule and execute any necessary tasks. For example, task scheduler 416 may schedule required tasks and provide appropriate corresponding task instructions to the aux devices 130 in electronic network 110.

In the FIG. 4A embodiment, command center 320 may utilize update module 420 to obtain and install updated or new versions of software programs on aux devices 130 or main device 126. In the FIG. 4A embodiment, command center 320 may utilize troubleshooter 426 to obtain any required troubleshooting information, and to perform troubleshooting procedures to diagnose and repair software or hardware malfunctions on aux devices 130 or main device 126.

In the FIG. 4A embodiment, communication module 436 supports bi-directional electronic communications between command center 320 and any other appropriate entities including, but not limited to, aux devices 130, support server 122, and network servers 124 (FIG. 1). In the FIG. 4A embodiment, registration module 440 may be utilized to perform any necessary registration procedures on the behalf of aux devices 130 or main device 126.

In the FIG. 4A embodiment, notification module 444 may support bi-directional notification messages between command center 320 and any other appropriate entities including, but not limited to, aux devices 130, support server 122, and network servers 124. For example, one or more aux devices 130 may automatically send a problem notification message to command center 320 regarding an operational or technical problem in electronic network 110. In response, command center 320 may provide appropriate support in any effective manner, depending upon the nature of the particular operational problem.

In the FIG. 4A embodiment, command center 320 may support device lookups/network map 448 which includes, but is not limited to, a fully-populated updateable network map of all aux devices 130 and main device 126 in electronic network 110. In addition, detailed device lookups of characteristics corresponding to each device in the network map are also available in device lookups/network map 448 for utilization by command center 320.

In the FIG. 4A embodiment, command center 320 may utilize product contacts/specifications 452 to access or determine any required type of technical or product information for aux devices 130 or main device 126. In certain embodiments, aux devices 130 may include various brands of electronic devices that are manufactured or sold by different commercial entities. In the FIG. 4A embodiment, miscellaneous information 456 may include any other type of information or functionalities for utilization by command center 320. For example, miscellaneous information 456 may include, but is not limited to, a hard-disk defragmentation manager, a device setup manager, and an antivirus module. Additional details regarding the implementation and utilization of command center 320 are further discussed below in conjunction with FIGS. 4B-8C.

Referring now to FIG. 4B, a diagram for one embodiment of the FIG. 3 task database 324 is shown, in accordance with the present invention. The FIG. 4B embodiment is presented for purposes of illustration, and in alternate embodiments, task database 324 may include components and information in addition to, or instead of, certain of those components and information discussed in conjunction with the FIG. 4B embodiment.

In the FIG. 4B embodiment, task database 324 includes a task A (480(a)) through a task N (480(n)) that are supported by command center 320. In the FIG. 4B embodiment, each task 480 is associated with corresponding task instructions. In certain embodiments a task scheduler 416 (FIG. 4A) may refer to task database 324 to schedule and execute any necessary tasks. For example, task scheduler 416 may schedule required tasks and provide appropriate corresponding task instructions to the aux devices 130 in electronic network 110. Additional details regarding the implementation and utilization of command centers 320 are further discussed below in conjunction with FIGS. 5 through 8

Referring now to FIG. 5, a block diagram for one embodiment of a FIG. 1 aux device 130 is shown, in accordance with the present invention. In the FIG. 5 embodiment, aux device 130 may include, but is not limited to, a central processing unit (CPU) 512, a display 516, a memory 520, and one or more input/output interface(s) (I/O interface(s)) 524. The foregoing components of aux device 130 may be coupled to, and communicate through, a bus 528.

In alternate embodiments, aux device 130 may be implemented using components and configurations in addition to, or instead of, certain of those components and configurations discussed in conjunction with the FIG. 5 embodiment. Furthermore, auxiliary device 130 may be implemented as any type of appropriate entity. For example, in certain embodiments, auxiliary device 130 may be implemented as any type of stationary or portable electronic device, such as a personal computer, a smart network-enabled television, a consumer-electronics device, a cellular telephone, a settop box, an audio-visual entertainment device, or a personal digital assistant (PDA).

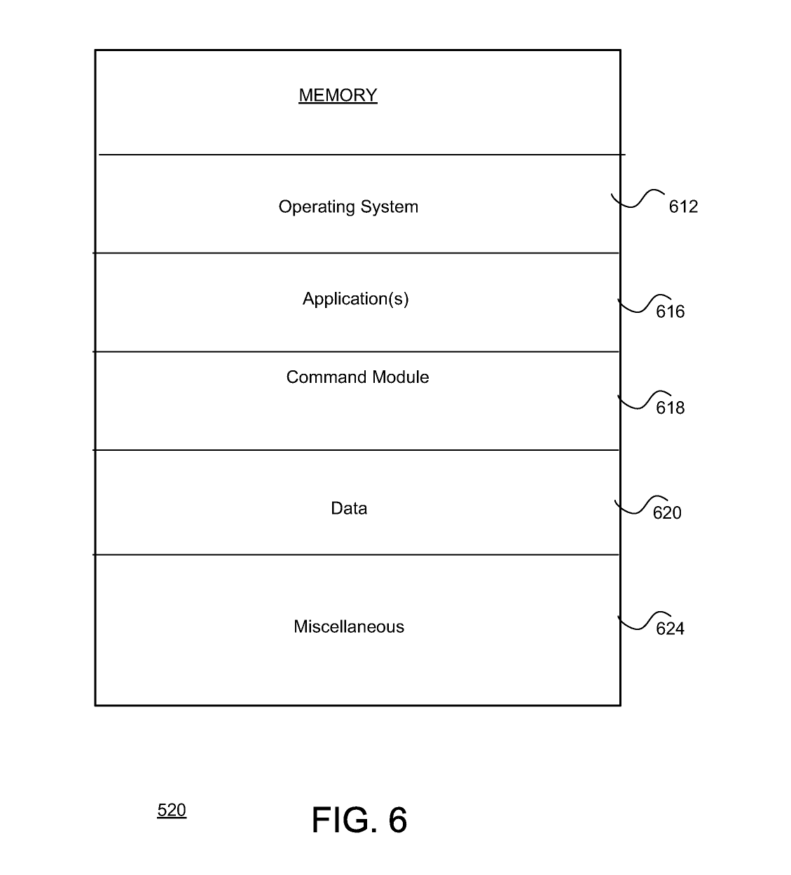

In the FIG. 5 embodiment, CPU 512 may be implemented to include any appropriate and compatible microprocessor device that preferably executes software instructions to thereby control and manage the operation of aux device 130. The FIG. 5 display 516 may include any effective type of display technology including a cathode-ray-tube monitor or a liquid-crystal display device with an appropriate screen for displaying various information to a device user. In the FIG. 5 embodiment, memory 520 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of memory 520 are further discussed below in conjunction with FIG. 6.

In the FIG. 5 embodiment, I/O interface(s) 524 may include one or more input and/or output interfaces to receive and/or transmit any required types of information by aux device 130. I/O interface(s) 524 may include one or more means for allowing a device user to communicate with other entities in electronic network 110 (FIG. 1). For example, the foregoing means may include a keyboard device, a wireless remote-control device, a speech-recognition module with corresponding microphone, a graphical user interface with touch-screen capability, a hand-held device controller unit, or a selection button array mounted externally on auxiliary device 130. The implementation and utilization of aux device 130 are further discussed below in conjunction with FIGS. 6-8.

Referring now to FIG. 6, a block diagram for one embodiment of the FIG. 5 memory 520 is shown, in accordance with the present invention. In the FIG. 6 embodiment, memory 520 includes, but is not limited to, an operating system 612, one or more applications 616, a command module 618, data 620, and miscellaneous items 624. In alternate embodiments, memory 520 may include components and functionalities in addition to, or instead of, certain of those components and functionalities discussed in conjunction with the FIG. 6 embodiment.

In the FIG. 6 embodiment, operating system 612 may perform various low-level functions for aux device 130. In the FIG. 6 embodiment, applications 616 may include program instructions that are preferably executed by a CPU 512 (FIG. 5) to perform various functions and operations for aux device 130. The particular nature and functionality of applications 612 typically varies depending upon factors such as the specific type and particular functionality of the corresponding aux device 130.

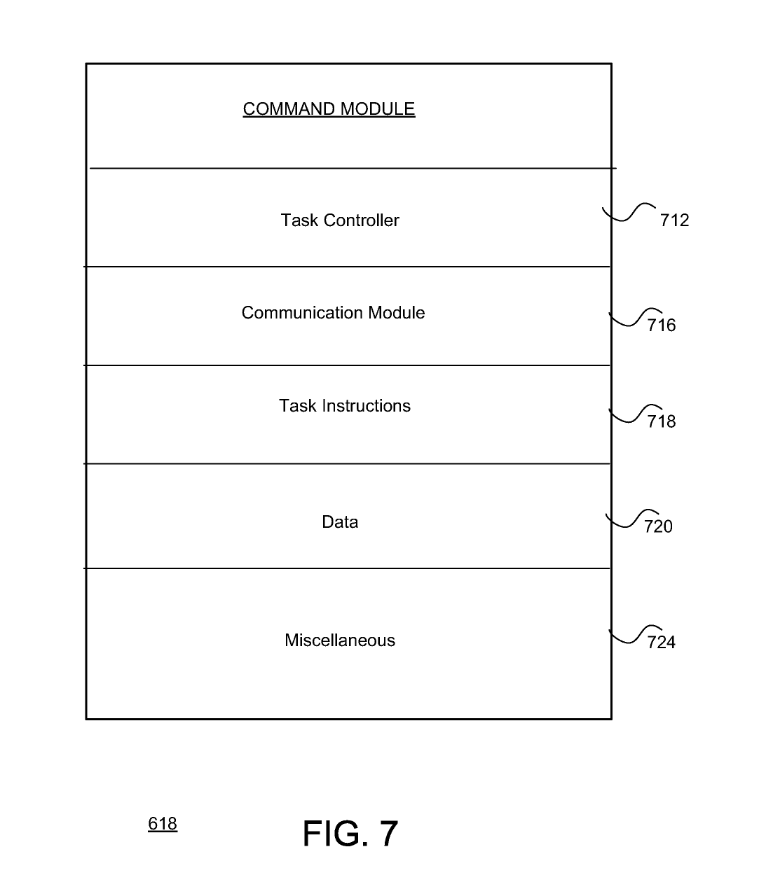

In the FIG. 6 embodiment, command module 618 may cooperate with command center 320 of main device 126 (FIG. 1) in any effective manner. One embodiment for command module 618 is further discussed below in conjunction with FIG. 7. In the FIG. 6 embodiment, data 620 may include any type of information for utilization by aux device 130. Miscellaneous information 624 may include any additional information that for utilization by aux device 130.

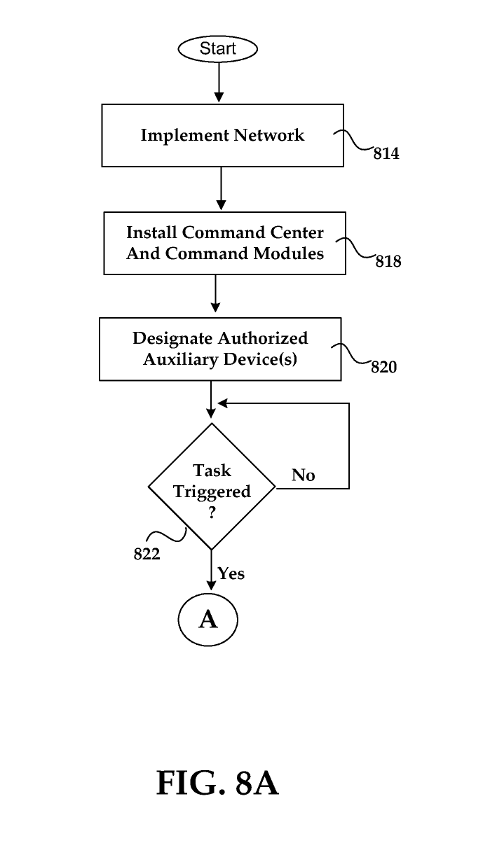

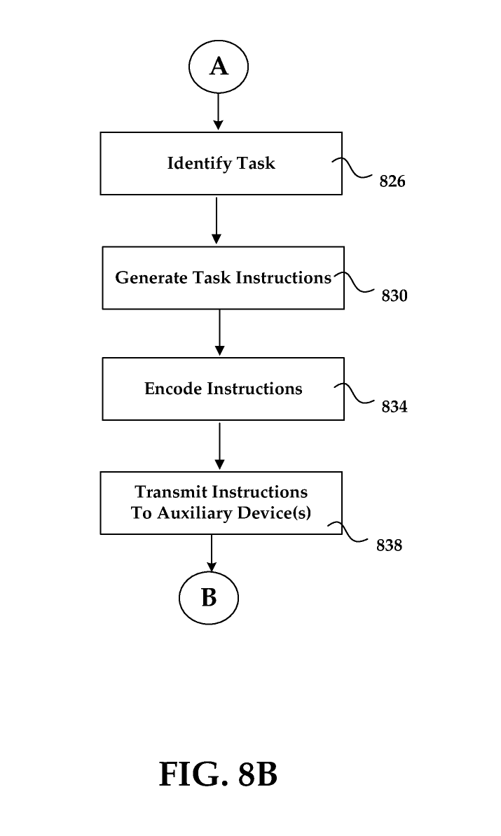

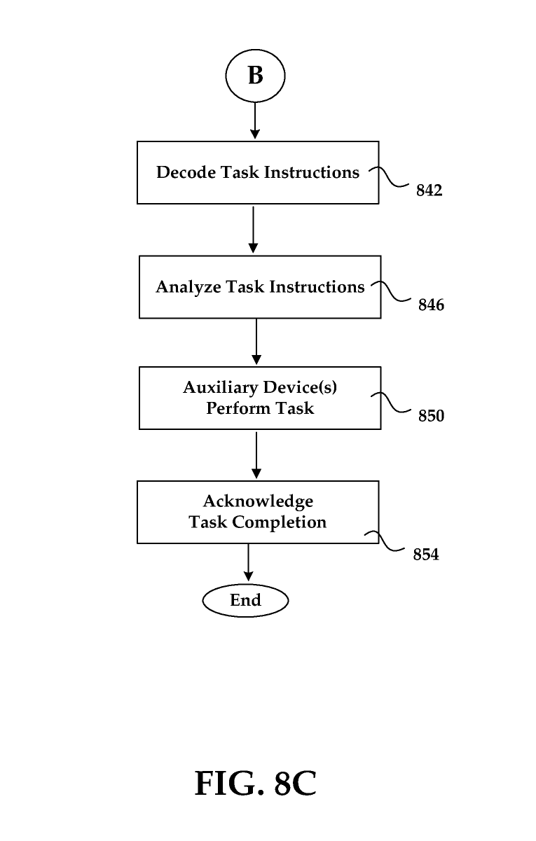

In the FIG. 6 embodiment, the present invention is disclosed and discussed as being implemented primarily as software. However, in alternate embodiments, some or all of the functions of the present invention may be performed by appropriate electronic hardware circuits that are configured for performing various functions that are equivalent to those functions of the software modules discussed herein. Additional details regarding the implementation and management of aux device 130 are further discussed below in conjunction with FIGS. 7-8.

Referring now to FIG. 7, a diagram for one embodiment of the FIG. 6 command module 618 is shown, in accordance with the present invention. In the FIG. 7 embodiment, command module 618 may include, but is not limited to, a task controller 712, a communication module 716, task instructions 718, data 720, and miscellaneous information. In alternate embodiments, command module 618 may include other components and information in addition to, or instead of, certain of those components and information discussed in conjunction with the FIG. 7 embodiment.

In the FIG. 7 embodiment, task controller 712 provides overall control, management, and coordination of the various functionalities of command module 618. For example, command module 618 may cooperate with command center 320 (FIG. 4A) to manage any necessary tasks for aux device 130. In the FIG. 7 embodiment, communication module 716 supports bi-directional electronic communications between command module 618 and any other appropriate entities including, but not limited to, command center 320 of main device 126 (FIG. 1).

In the FIG. 7 embodiment, data 720 may include any type of information for utilization by command module 618. In the FIG. 7 embodiment, miscellaneous information 724 may include any other type of information or functionalities for utilization by command module 618. Additional details regarding the implementation and utilization of command module 618 are further discussed below in conjunction with FIG. 8.

Referring now to FIGS. 8A-8C, a flowchart of method steps for utilizing a command center to perform a device management procedure in an electronic network is shown, in accordance with one embodiment of the present invention. The FIG. 8 flowchart is presented for purposes of illustration, and in alternate embodiments, the present invention may utilize steps and sequences other than those steps and sequences discussed in conjunction with the FIG. 8 embodiment.

In step 814 of FIG. 8A, an electronic network 110 may be implemented to include a main device 126 and one or more auxiliary devices 130. In various different embodiments, the main device 126 and the auxiliary devices 130 may include any appropriate types of electronic devices. In step 818, an entity such as a system user or a manufacturer may install a command center 320 on the main device 126, and may further install respective command modules 618 on the auxiliary devices 130. In step 820, an appropriate entity such as a system administrator may designate which auxiliary devices 130 are authorized to participate in device management procedures controlled by the command center 320.

In step 822, the command center 320 determines whether a task has been triggered in any effective manner. In various embodiments, a task may be triggered in response to a corresponding trigger event that occurs in the electronic network 110. For example, one or more auxiliary devices 130 may communicate with command center 320 to provide notifications about specific trigger events. Alternately, command center 320 may affirmatively detect the trigger events in any effective manner. If the command center 320 determines that a task has been triggered in step 822, then the FIG. 8A process advances to step 826 of FIG. 8B through connecting letter “A.”

In step 826, the command center 320 identifies the specific task that has been triggered in any effective manner. For example, the command center 320 may reference a task database 324 (FIG. 4B). In step 830, the command center 320 may then generate corresponding task instructions by utilizing any appropriate techniques. For example, suitable task instructions may be associated with respective supported tasks in the task database 324.

In step 834, the command center 320 may encode or encrypt the task instructions in any effective manner. In step 838, the command center 320 may transmit the task instructions to at least one appropriate target auxiliary device 130. The FIG. 8B process then advances to step 842 of FIG. 8C through connecting letter “B.” In step 842, a command module 618 of the auxiliary device 130 may decode or decrypt the task instructions by utilizing any effective techniques.

In step 846, the command module 618 of the auxiliary device 130 performs an analysis procedure on the task instructions to prepare for correctly executing the task instructions. In step 850, the command module 618 of the auxiliary device 130 performs the specified task according to the received task instructions. Finally, in step 854, the command module 618 acknowledges to the command center 320 on the main device 126 that the task instructions have been executed and the task has been completed. The FIG. 8 procedure may then terminate. For at least the foregoing reasons, the present invention therefore provides an improved system and method for utilizing a command center to perform a device management procedure in an electronic network.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A method for managing an electronic network, comprising:
providing a main device that includes a command center for performing device management procedures in said electronic network;
connecting at least one auxiliary device to said electronic network, said auxiliary device including a command module that bi-directionally communicates with said command center to receive device control information during said device management procedures; and
utilizing a main processor of said main device to control said command center.

2. The method of claim 1 wherein said electronic network is implemented with consumer electronics devices in a home environment.

3. The method of claim 1 wherein said command center determines that a trigger event has occurred requiring that a corresponding task be performed in said auxiliary device.

4. The method of claim 3 wherein said command center identifies said task, accesses task instructions associated with said task from a task database, and transmits said task instructions to said auxiliary device.

5. The method of claim 4 wherein said command module receives and analyzes said task instructions, said command module then causing said auxiliary device to execute said task instructions, said command module confirming a successful completion of said task to said command center.

6. The method of claim 5 wherein said task instructions are securely encoded by said command center, said task instructions being decoded by said command module.

7. The method of claim 1 wherein said command center includes a task scheduler, an update module, a security module, a troubleshooter, a communication module, a registration module, a notification module, a hard-disk defragmentation manager, a setup manager, and an antivirus module for performing said device management procedures for said auxiliary device, said command center being alternately updateable both with a new software release and by downloading new/updated modules from a support server.

8. The method of claim 1 wherein said command center supports an updateable network map of said electronic network.

9. The method of claim 1 wherein said command center has access to product contacts and product specifications for said auxiliary devices, said command center accessing one or more network servers to obtain certain of said product contacts and product specifications for said auxiliary devices.

10. The method of claim 1 wherein said command center performs bi-directional communications with a support server to obtain remote technical support for said auxiliary devices.

11. A main device that manages an electronic network, comprising:
a command manager configured to perform device management procedures for at least one auxiliary device in said electronic network, said auxiliary device including a command module that bi-directionally communicates with said command manager to receive device control information during said device management procedures; and
a main processor that controls said command center.

12. The main device of claim 11 wherein said electronic network is implemented with consumer electronics devices in a home environment.

13. The main device of claim 11 wherein said command center determines that a trigger event has occurred requiring that a corresponding task be performed in said auxiliary device.

14. The main device of claim 13 wherein said command center identifies said task, accesses task instructions associated with said task from a task database, and transmits said task instructions to said auxiliary device.

15. The main device of claim 14 wherein said command module receives and analyzes said task instructions, said command module then causing said auxiliary device to execute said task instructions, said command module confirming a successful completion of said task to said command center.

16. The main device of claim 15 wherein said task instructions are securely encoded by said command center, said task instructions being decoded by said command module.

17. The main device of claim 11 wherein said command center includes a task scheduler, an update module, a security module, a troubleshooter, a communication module, a registration module, a notification module, a hard-disk defragmentation manager, a setup manager, and an antivirus module for performing said device management procedures for said auxiliary device, said command center being alternately updateable both with a new software release and by downloading new/updated modules from a support server.

18. The main device of claim 11 wherein said command center supports an updateable network map of said electronic network.

19. The main device of claim 11 wherein said command center has access to product contacts and product specifications for said auxiliary devices, said command center accessing one or more network servers to obtain certain of said product contacts and product specifications for said auxiliary devices.

20. The main device of claim 11 wherein said command center performs bi-directional communications with a support server to obtain remote technical support for said auxiliary devices.
